(19) United States
(12) Patent Application Publication
(10) Pub. No.: US 2013/0135071 A1
(43) Pub. Date: May 30, 2013

(54) SYSTEM AND METHOD FOR FOCUSING MAGNETIC FIELDS

(71) Applicant: Correlated Magnetics Research, LLC., New Hope, AL (US)

(72) Inventors: Mark D. Roberts, Huntsville, AL (US); Larry W. Fullerton, New Hope, AL (US); Kelly Loum, Athens, AL (US)

(73) Assignee: Correlated Magnetics Research, LLC., New Hope, AL (US)

(21) Appl. No.: 13/687,819

(22) Filed: Nov. 28, 2012

Related U.S. Application Data
(60) Provisional application No. 61/629,806, filed on Nov. 28, 2011.

(51) Int. Cl. H01F 7/02

(52) U.S. Cl. CPC H01F 7/02
USPC 335/306

(57) ABSTRACT

An improved system and method for focusing magnetic fields involves two aligned correlated magnetic structures each comprising an inner portion and an outer portion surrounding the inner portion where the inner portion and the outer portion have an opposite polarity relationship. The focused field magnetic structures produce composite magnetic fields where surface fields have substantially greater field strength than side fields.

### CLAIMING BENEFIT OF PRIOR FILED U.S. APPLICATIONS

This Non-provisional Patent Application claims the benefit of U.S. Provisional Patent Application No. 61/629,806, filed Nov. 28, 2011, titled “System and Method for Focusing Magnetic Fields”, which is incorporated herein by reference.

### FIELD OF THE INVENTION

The present invention relates generally to correlated magnetic structures that produce focused magnetic fields. More particularly, the present invention relates to correlated magnetic structures where the field strengths of the magnetic fields to the sides of the correlated magnetic structures are tailored to be low or substantially zero at a desired distance from the correlated magnetic structures and are generally low compared to magnetic field strengths of the magnetic fields between the surfaces of the correlated magnetic structures.

### BACKGROUND OF THE INVENTION

For certain applications, various devices use magnet pairs that produce vertical forces for some useful purpose, where it is undesirable for there to be horizontal forces between nearby magnet pairs. As such, when conventional magnets are used in such applications it is necessary to separate the magnet pairs by substantial distances so as to isolate the magnet pairs from each other. Spreading the magnet pairs apart by substantial distances ultimately limits the number of devices that can be present in a given area (or volume). For certain other applications, it may be desirable to sharpen a magnetic field of a single magnet, for example, to enable the magnet to more precisely affect properties of a magnetically sensitive material. It is therefore desirable for improved systems and methods for focusing magnetic fields of a magnet or a magnet pair.

U.S. Pat. No. 6,387,096 teaches mixing magnets to create increased fields in the center of the structure and smaller fields on outer portions of the structure (FIG. 1H) and vice versa. This art appears to concern magnetic structures that produce fields having magnetic peaks and valleys above the surfaces of the structures used to cause the magnetic structures to maintain alignment when used to treat adjacent bone portions. The disclosure does not appear to concern focusing magnetism so as to purposely diminish side fields compared to surface fields.

The correlated magnetic structures described herein can be described as being “focusable” correlated magnetic structures, which does not necessarily mean they focus magnetism the same way waves are focused. Correlated magnetics was first fully described and enabled in U.S. Pat. No. 7,800,471, issued on Sep. 21, 2010, and entitled “A Field Emission System and Method”. The contents of this document are hereby incorporated herein by reference. A second generation of a correlated magnetic technology is described and enabled in co-assigned U.S. Pat. No. 7,868,721 issued on Jan. 11, 2011, and entitled “A Field Emission System and Method”. The contents of this document are hereby incorporated herein by reference. A third generation of a correlated magnetic technology is described and enabled in the co-assigned U.S. Pat. No. 8,179,219, issued on May 15, 2012, and entitled “A Field Emission System and Method”. The contents of this document are hereby incorporated herein by reference. Another technology known as correlated inductance, which is related to correlated magnetics, has been described and enabled in the co-assigned U.S. Pat. No. 8,115,581, issued on Feb. 14, 2012, and entitled “A System and Method for Producing an Electric Pulse”. The contents of this document are hereby incorporated by reference.

Material presented herein may relate to and/or be implemented in conjunction with multilevel correlated magnetic systems and methods for producing a multilevel correlated magnetic system such as described in U.S. Pat. No. 7,982,568 issued Jul. 19, 2011 which is all incorporated herein by reference in its entirety. Material presented herein may relate to and/or be implemented in conjunction with energy generation systems and methods such as described in U.S. patent application Ser. No. 13/184,543 filed Jul. 17, 2011, which is all incorporated herein by reference in its entirety. Such systems and methods described in U.S. Pat. No. 7,681,256 issued Mar. 23, 2010, U.S. Pat. No. 7,750,781 issued Jul. 6, 2010, U.S. Pat. No. 7,755,462 issued Jul. 13, 2010, U.S. Pat. No. 7,812,698 issued Oct. 12, 2010, U.S. Pat. Nos. 7,817,002, 7,817,003, 7,817,004, 7,817,005, and 7,817,006 issued Oct. 19, 2010, U.S. Pat. No. 7,821,367 issued Oct. 26, 2010, U.S. Pat. Nos. 7,823,300 and 7,824,083 issued Nov. 2, 2011, U.S. Pat. No. 7,834,729 issued Nov. 16, 2011, U.S. Pat. No. 7,839,247 issued Nov. 23, 2010, U.S. Pat. Nos. 7,843,295, 7,843,296, and 7,843,297 issued Nov. 30, 2010, U.S. Pat. No. 7,893,803 issued Feb. 22, 2011, U.S. Pat. Nos. 7,956,711 and 7,956,712 issued Jun. 7, 2011, U.S. Pat. Nos. 7,958,575, 7,961,068 and 7,961,069 issued Jun. 14, 2011, U.S. Pat. No. 7,963,818 issued Jun. 21, 2011, and U.S. Pat. Nos. 8,015,752 and 8,016,330 issued Sep. 13, 2011, and U.S. Pat. No. 8,035,260 issued Oct. 11, 2011 are all incorporated by reference herein in their entirety.

Material presented herein may relate to and/or be implemented in conjunction with magnetization, shunting, and related coding techniques such as those disclosed in U.S. patent application Ser. No. 13/240,355, filed Sep. 22, 2011, U.S. patent application Ser. No. 13/374,074, filed Dec. 9, 2011, and U.S. patent application Ser. No. 13/481,554, filed May 25, 2012, which are incorporated by reference herein in their entirety.

### SUMMARY OF THE INVENTION

In one aspect, an example embodiment is directed to a system for focusing magnetic fields that includes a first focused field magnetic structure comprising a first inner portion and a first outer portion, the first inner portion being inside the first outer portion, the first inner portion and the first outer portion being magnetized to have an opposite polarity relationship, and a second focused field magnetic structure comprising a second inner portion and a second outer portion, the second inner portion being inside the second outer portion, the second inner portion and the second outer portion being magnetized to have an opposite polarity relationship.

The first focused field magnetic structure and the second focused field magnetic structure may produce a composite magnetic field where surface fields inside the first and second outer portions have substantially greater field strength than side fields outside the first and second outer portions.

The first focused field magnetic structure may comprise a monolithic substrate.

The second focused field magnetic structure may comprise a monolithic substrate.

The first focused field magnetic structure may comprise a first substrate having an axial magnetization profile and a second substrate having an axial magnetization profile.

The second focused field magnetic structure may comprise a first substrate having an axial magnetization profile and a second substrate having an axial magnetization profile.

The system may include a movement constraining device that constrains at least one of rotational movement or translational movement of at least one of the first focused field magnetic structure or the second focused field magnetic structure.

The magnetization of the first outer portion may be symmetrical.

The magnetization of the second outer portion may be symmetrical.

The first inner portion may be round and the first outer portion may be a ring.

The second inner portion may be round and the second outer portion may be a ring.

At least one of the first focused field magnetic structure or the second focused field magnetic structure may comprise a pattern of concentric rings.

In another aspect, an example embodiment is directed to a method for focusing magnetic fields comprising the steps of providing a first focused field magnetic structure comprising a first inner portion and a first outer portion, the first inner portion being inside the first outer portion, the first inner portion and the first outer portion being magnetized to have an opposite polarity relationship, and

providing a second focused field magnetic structure comprising a second inner portion and a second outer portion, the second inner portion being inside the second outer portion, the second inner portion and the second outer portion being magnetized to have an opposite polarity relationship.

The first focused field magnetic structure may be a monolithic substrate that is axially magnetized prior to the first outer portion being magnetized to have the opposite polarity relationship.

The second focused field magnetic structure may be a monolithic substrate that is axially magnetized prior to the second outer portion being magnetized to have the opposite polarity relationship.

The first focused field magnetic structure may comprise a first substrate having an axial magnetization profile and a second substrate having an axial magnetization profile.

The second focused field magnetic structure may comprise a first substrate having an axial magnetization profile and a second substrate having an axial magnetization profile.

The first focused field magnetic structure and the second focused field magnetic structure may produce a composite magnetic field where surface fields inside the first and second outer portions have substantially greater field strength than side fields outside the first and second outer portions.

The method may further include the step of constraining at least one of rotational movement or translational movement of at least one of the first focused field magnetic structure or the second focused field magnetic structure.

At least one of the first focused field magnetic structure or the second focused field magnetic structure may comprise a pattern of concentric rings.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A depicts a conventional magnet that has been axially magnetized using a homogeneous magnetization process;

FIG. 1B depicts two conventional magnets of FIG. 1A oriented in a first repel orientation;

FIG. 1C depicts two conventional magnets of FIG. 1A oriented in a second repel orientation;

FIG. 2 depicts two conventional magnets in a repel orientation having zero horizontal separation and a vertical separation of 13 mm;

FIG. 3 depicts two conventional magnets in a repel orientation having a horizontal separation of 130 mm and a vertical separation of 13 mm;

FIG. 4 depicts two conventional magnets in a repel orientation having zero horizontal separation and a vertical separation of 40 mm;

FIG. 5 depicts two conventional magnets in a repel orientation having a horizontal separation of 130 mm and a vertical separation of 40 mm;

FIG. 6 depicts the vertical force variation between two magnets as a top magnet moves from between a horizontal offset of 130 mm to directly over the bottom magnet for vertical separations of 13 mm and 40 mm;

FIG. 7 shows the simulated force curves superimposed on the empirical force curves from FIG. 6;

FIG. 8 depicts an exemplary model consisting of a corner magnet pair and two adjacent magnet pairs;

FIG. 9 shows a cutaway view of the exemplary magnetization pattern of the code used in the focused field magnetic structure design;

FIG. 10 depicts the geometry of the exemplary simulation model of the focused field magnetic structure design;

FIG. 11 provides a side view of the simulated magnetic field strength of the magnetic structures of the model of FIG. 10;

FIG. 12 depicts an exemplary tensile force vs. separation distance curve between the top and bottom magnetic structures of a single correlated magnetic structure pair as simulated;

FIG. 13 depicts an exemplary surface plot of the vertical magnetic field component 0.5 mm above the surface of a prototype correlated magnetic structure;

FIG. 14 depicts an exemplary contour plot of the vertical magnetic field component 0.5 mm above the surface of a prototype correlated magnetic structure;

FIG. 15 shows the force curve of measured data superimposed with the simulated-force data curve from FIG. 12;

FIG. 16 depicts the measured horizontal force between two top magnetic structures of two adjacent magnetic structure pairs for each of several horizontal separation distances;

FIGS. 17A and 17B depict alternative shapes for magnetic structures in accordance with embodiments of the present invention; and

FIG. 18 depicts an exemplary focusable correlated magnetic structure array and sensors.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

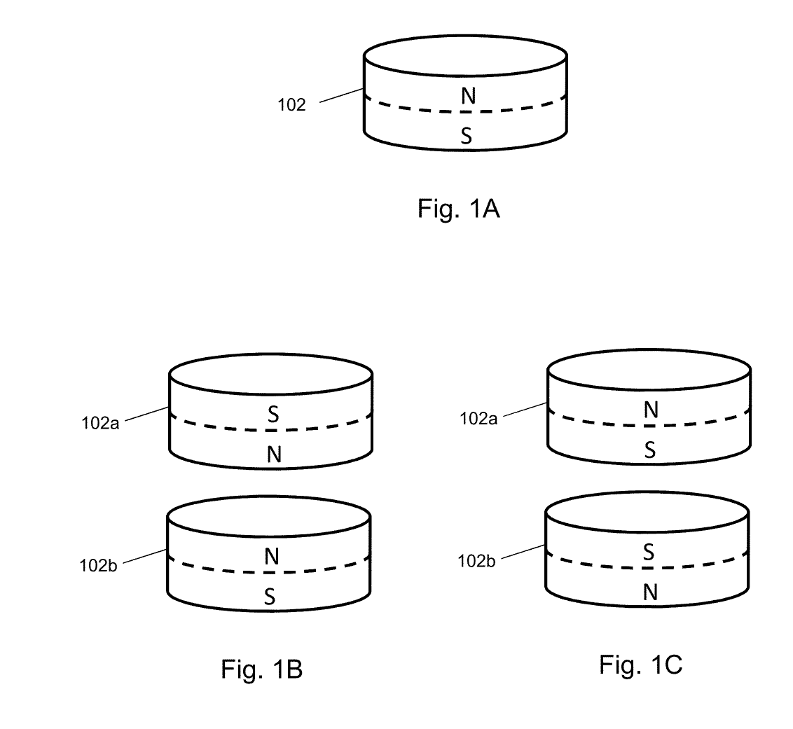

The magnetic field behavior of magnets has been well understood and, aside from materials improvements such as rare-earth materials, magnets have been used in much the same way for the more than a century. During this time, machines have been designed to work with the fixed behavior of what is referred to herein as ‘conventional magnets’ that have a North Pole and a South Pole, where the magnetic field magnitude decreases with the square of the separation distance between two magnets. FIG. 1A depicts a conventional magnet 102, which has been axially magnetized using a homogeneous magnetization process. As shown, the conventional magnet 102 has a North polarity side (N) and a South polarity side (S). FIG. 1B depicts two conventional magnets 100a 100b oriented in a first repel orientation, where two North polarity sides (N) face each other and FIG. 1C depicts two conventional magnets 100a 100b oriented in a second repel orientation, where two South polarity sides (S) face each other. For either repel orientation, a repel force is produced between the two magnets 102a 102b.

The depicted embodiments of present invention provides a system and method for focusing magnetic fields of correlated magnetic structures that are magnetized such that each structure comprises an inner portion and an outer portion surrounding the inner portion where the inner portion and the outer portion have an opposite polarity relationship. These magnetic structures produce composite focused magnetic fields where surface fields have substantially greater field strength than side fields.

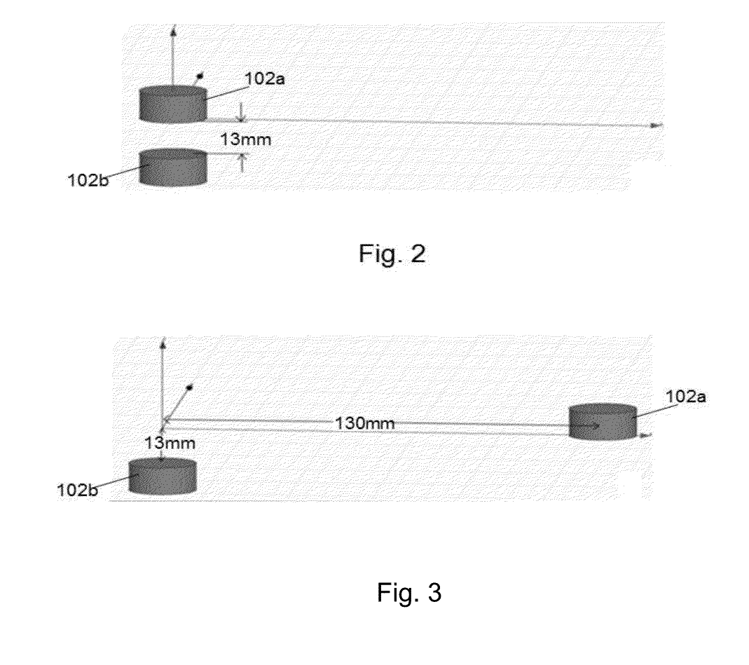

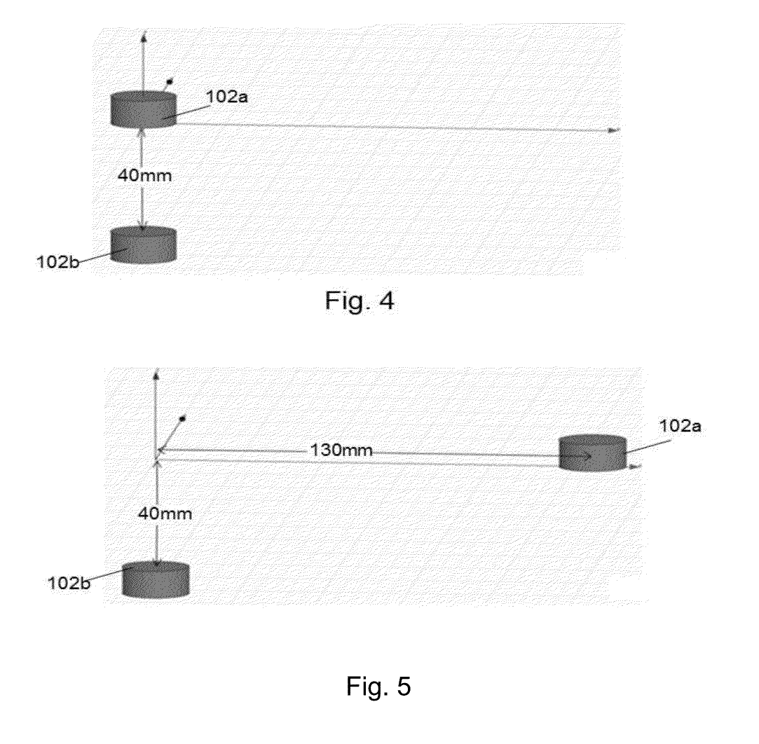

In order to characterize conventional magnetic field behavior so as to provide a performance baseline to compare to focused magnetic field behavior, two empirical force curve experiments were performed using vertical pairs of 10 mm high×20 mm diameter conventional magnets. Each experiment measured the vertical component of the force on a top magnet as that magnet moved horizontally some distance above a bottom magnet. For both experiments the horizontal movement was from a horizontal (X) offset of 130 mm relative to the bottom magnet and a zero horizontal offset, where the top magnet was directly above the bottom magnet. For one experiment the vertical (Z) separation between the bottom and top magnets was 13 mm, and for the other it was 40 mm. FIG. 1 shows the zero X offset position of a first conventional magnet 102a relative to a second conventional magnet 102b, where the two magnets are separated vertically by 13 mm. FIG. 2 shows the 130 mm X offset position of the first conventional magnet 102a relative to the second conventional magnet 102b, where the two magnets are separated vertically by 13 mm. Similarly, FIG. 4 shows the zero X offset position of the first conventional magnet 102a relative to a second conventional magnet 102b, where the two magnets are separated vertically by 40 mm, and FIG. 5 shows the 130 mm X offset position of the first conventional magnet 102a relative to the second conventional magnet 102b, where the two magnets are separated vertically by 40 mm.

One skilled in the art will recognize that the separation distances in the vertical and horizontal directions can be translated to an angular orientation of the magnetic structures and that hereby prior art antenna design theories can be applied to design magnetic field characteristics in accordance with embodiments of the present invention.

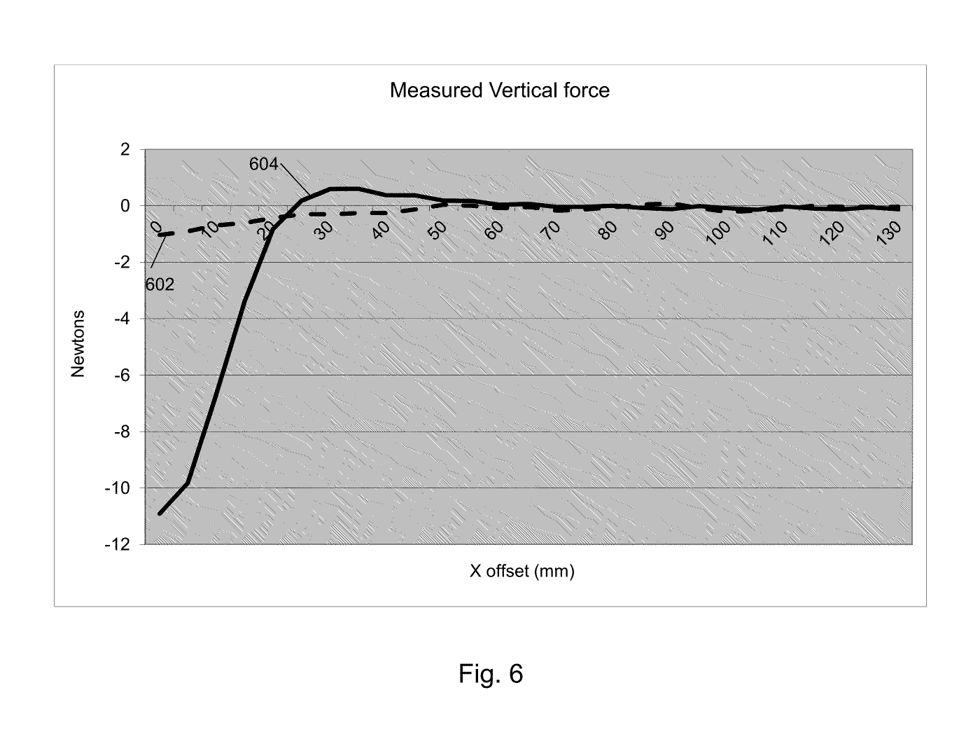

FIG. 6 shows the vertical force variation between two magnets as a top magnet moves from a horizontal offset of 130 mm to directly over the bottom magnet. The dashed curve 602 is for a vertical separation between the bottom and top magnets of 40 mm and the solid curve 604 is for a vertical separation of 13 mm.

Two numerical models were created used geometry identical to the two empirical force curve experiments so that permeability and material grade values could be calibrated. A relative permeability of 1.1 and a coercivity of 900 kA/m were found to best match empirical data, which are comparable to typical attributes of N42 grade NIB material.

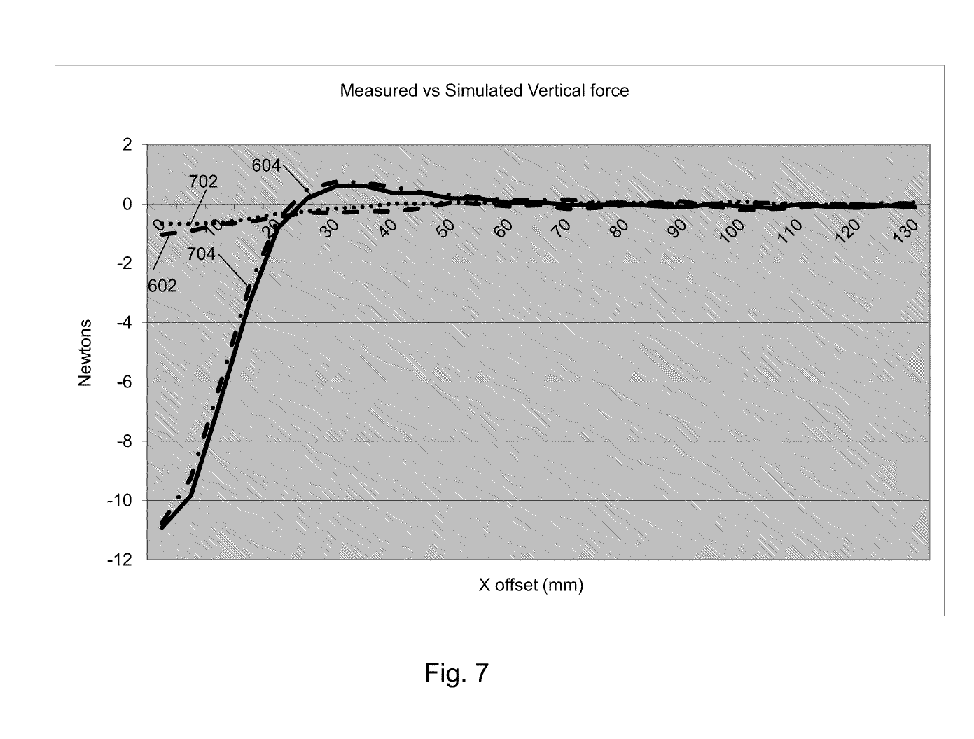

FIG. 7 shows the simulated force curves superimposed on the empirical force curves from FIG. 6. The dotted curve 702 and the dash dot curve 704 are the simulated curves corresponding to the measured dashed curve 602 and solid curve 604, respectively.

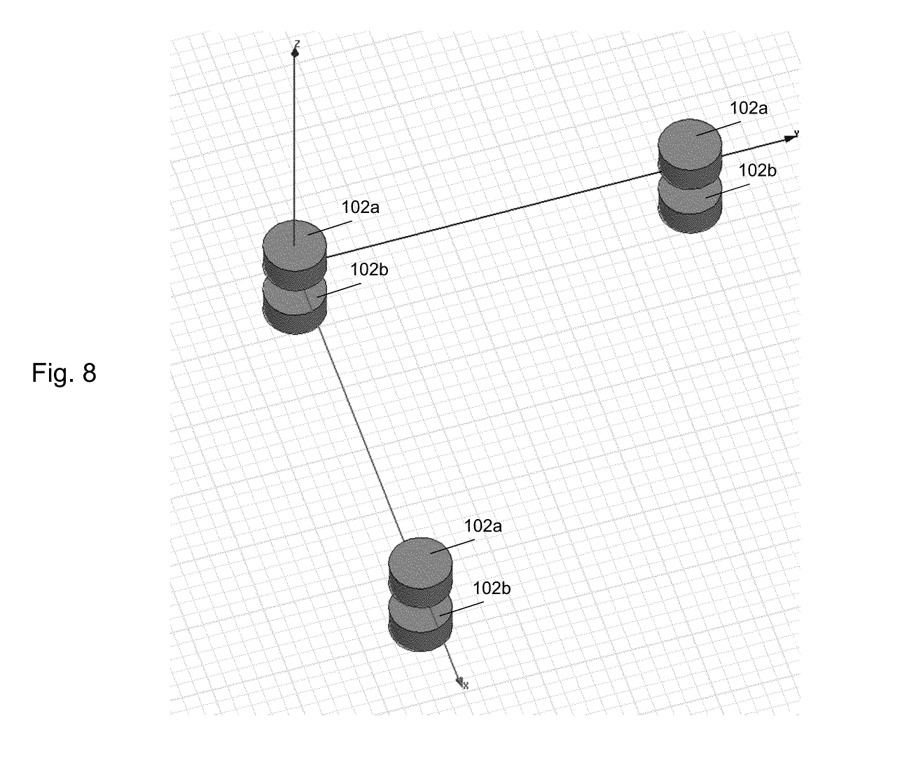

Using the established permeability and the material grade values, a more complex numerical model was created consisting of a corner magnet pair having 130 mm horizontal separation from each of two adjacent magnet pairs with each of the three magnet pairs comprising a top and bottom magnet having a vertical separation of 13 mm, as shown in FIG. 8. This model was used to find the maximum horizontal force on the top magnet of the corner magnet pair resulting from the presence of the top magnets of the adjacent magnet pairs.

Numerical simulation showed the top magnet of the corner magnet pair experienced a strongest horizontal force of 0.024 newtons when both bottom magnets in the adjacent magnet pairs were at their highest point (i.e., 13 mm vertical separation from top magnets in the adjacent magnet pairs), where the vertical force on the top magnet of the corner magnet pair varied between 10.6 and 0 newtons as the vertical separation with the bottom magnet of the corner magnet pair varied between 13 and 40 mm.

Additionally, a numerical model was created for conventional magnet pairs configured as in FIG. 8 but with a separation of 5 mm between top and bottom magnets. The vertical force in that case between the top and bottom magnets of the corner magnet pair was 35.8N.

In accordance with one embodiment of the invention, correlated magnetic structures that produce focused magnetic fields have designs based on concentric circle coding methods. For such designs, an optimal geometry and set of code parameters can be obtained through optimetric simulation. Two variations of a focused field magnetic structure design are briefly examined via simulation.

The focused field magnetic structure design possesses the following attributes:
The top and bottom substrates of magnetic structure pairs are identical.
The top and bottom substrates are monolithic.
The top and bottom substrates are about half the size of the conventional magnets used in empirical experiments.
The undesirable force between adjacent magnetic structure pairs is notably less than conventional magnet pairs, allowing magnetic structure pairs to be placed closer together than conventional magnet pairs without presence of undesirable horizontal forces.
Coding has circular symmetry, simplifying mechanical design and reducing the risk of improper installation.

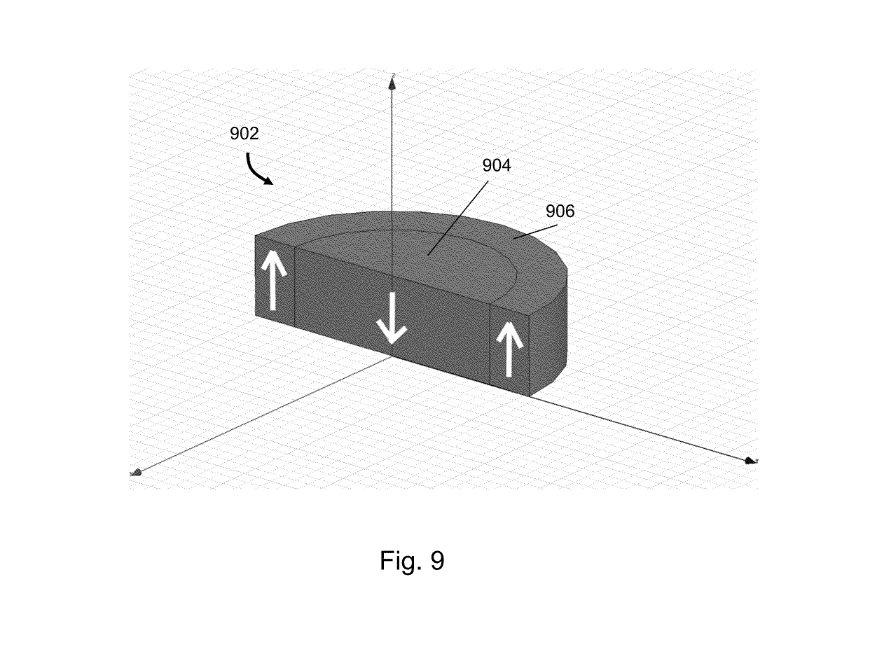

FIG. 9 shows a cutaway view of the magnetization pattern of the code used in the focused field magnetic structure design. The magnetic structure 902 includes an inner portion 904 having a first polarity and an outer portion 906 having a second polarity that is opposite the first polarity. White arrows indicate direction of magnetization. The magnetization is circularly symmetric. Generally, ring diameters, exact direction of magnetization, and differences between each correlated magnetic structure in a pair can be tailored for precise performance. The design described above uses the magnetization direction shown, where the magnetic structures in a pair are identical but one skilled in the art will recognize the directions of magnetization can be reversed or otherwise arranged.

Numeric analysis of the focused field magnetic structure design was performed using the Ansoft Maxwell magnetostatic simulator and proprietary magnetostatic simulator software.

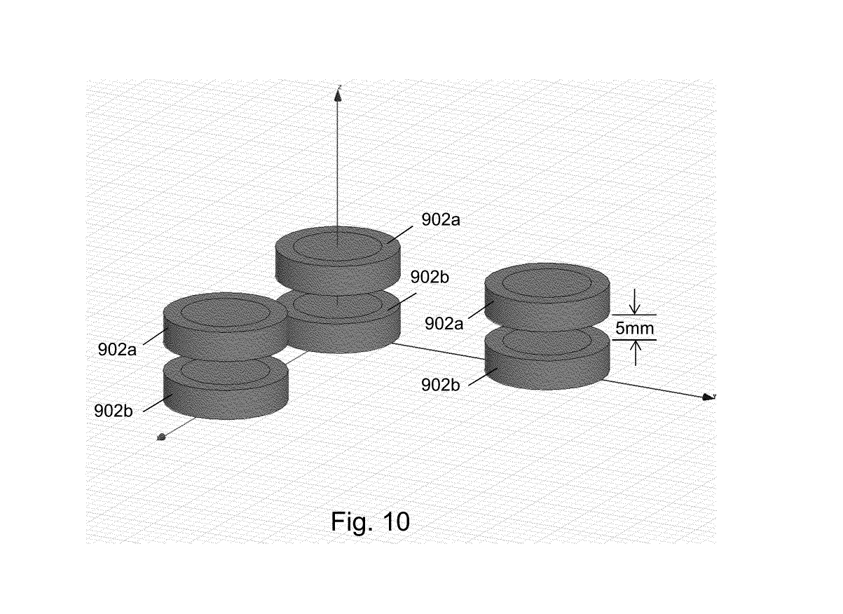

The geometry of the simulation model of the focused field magnetic structure design is shown in FIG. 10, which is similar to the conventional magnet pair model described in relation to FIG. 8. The model geometry includes three correlated magnetic structure pairs including a corner magnetic structure pair and two adjacent magnetic structure pairs each separated from the corner magnetic structure by pair 39.3 mm, where each magnetic structure pair includes a top magnetic structure 902a and a bottom magnetic structure 902b having been magnetized in accordance with this embodiment of the invention. Although a minimum vertical separation between top and bottom magnetic structures of 5 mm is shown in FIG. 10, the model allows the vertical separation to vary.

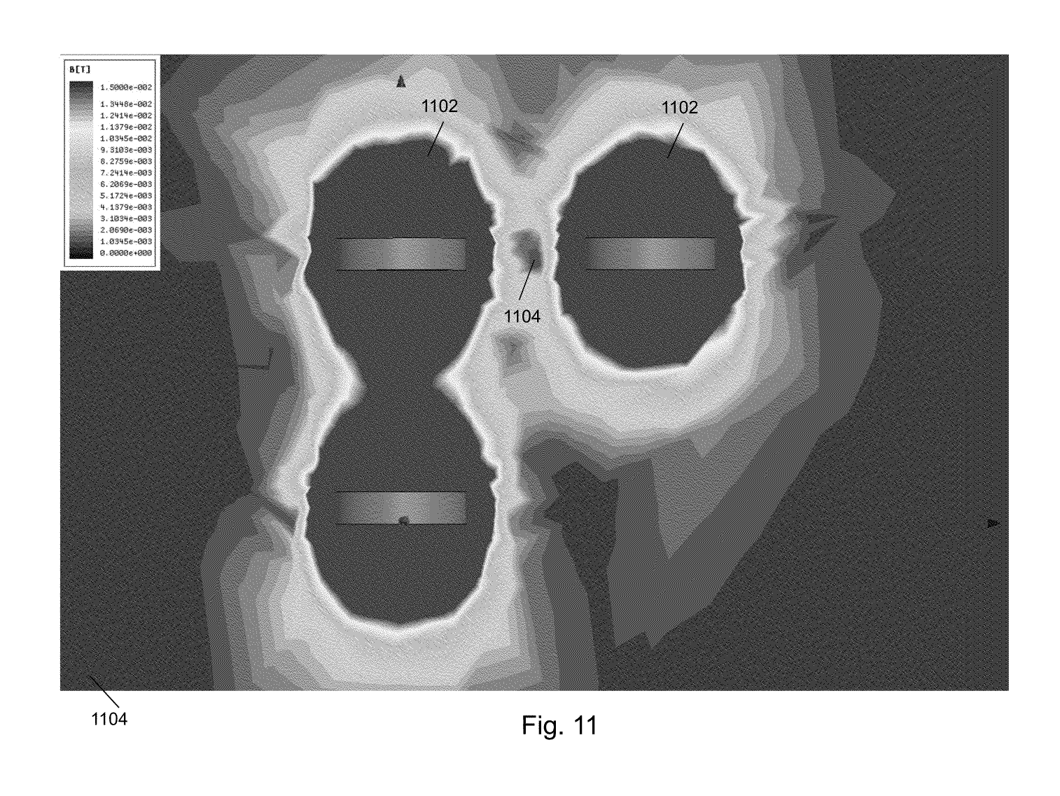

FIG. 11 provides a side view of the simulated magnetic field strength of the magnetic structures. The figure includes a top and bottom magnetic structure pair at 35 mm vertical separation and one adjacent top correlated magnetic structure. The strongest field 1102 surrounds the magnetic structures and the weakest field 1104 is furthest away from the structures but is also present in a small null region between the two top magnetic structures. One skilled in the art will understand that magnetic fields vary smoothly and that the jagged appearance of the field gradients arises from the limited precision of the finite element analysis model. One skilled in the art will recognize that prior art antenna design theory can be applied to design magnetic field characteristics in accordance with the present invention.

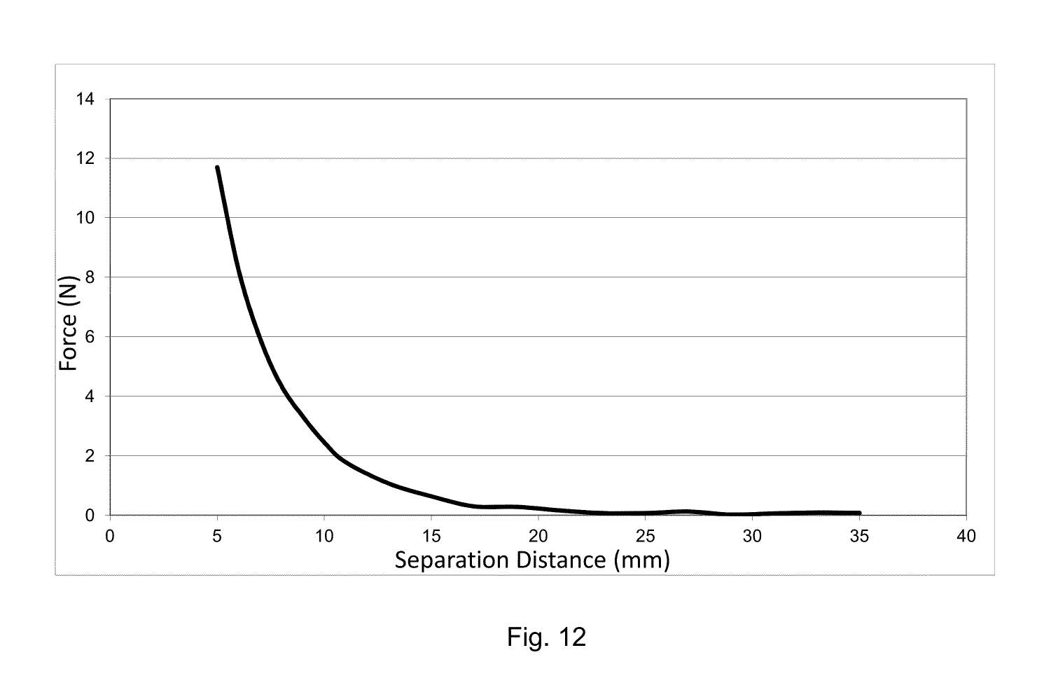

Table 1 lists the simulated tensile force between the top and bottom magnetic structures of a single correlated magnetic structure pair for each of several vertical separation distances. FIG. 12 shows the force curve of that data.

TABLE 1
Simulated attractive force between the top and bottom
correlated magnetic structures vs. distance between
the facing surfaces of those correlated magnetic structures

| Separation (mm) | Force (N) |
|---|---|
| 5 | 11.70126355 |
| 6 | 8.237817021 |
| 7 | 5.939505699 |
| 8 | 4.3471917 |
| 9 | 3.316350698 |
| 10 | 2.448342894 |
| 11 | 1.781377193 |
| 13 | 1.070040673 |
| 15 | 0.633212122 |
| 17 | 0.297911628 |
| 19 | 0.281974626 |
| 21 | 0.159797083 |
| 23 | 0.071487948 |
| 25 | 0.070747142 |
| 27 | 0.123584815 |
| 29 | 0.020115064 |
| 31 | 0.061665906 |
| 33 | 0.088760089 |
| 35 | 0.076882995 |

The simulated maximum horizontal force applied to the top correlated magnetic structure of a corner magnetic structure pair when bottom magnetic structures of adjacent magnetic structure pairs are at their highest position (i.e., 5 mm) was less than 0.01N.

Two variations in the basic design were simulated. The first variation added a 1 mm steel shunt plate to the underside of the bottom correlated magnetic structure. The simulation showed that with this variation the maximum tensile force at 5 mm separation between the top and bottom correlated magnetic structures increases from 11.7N to 13.45N. Although not simulated, alternatively or additionally, a comparable shunt plate could be placed on top of the upper correlated magnetic structure to produce similar force increases. The second variation included the shunt plate on the underside of the bottom structure and also increased the thickness of the bottom correlated magnetic structure to 9.5 mm. Simulation showed that with this variation the maximum tensile force at 5 mm separation between the top and bottom correlated magnetic structures increases to 14.8N. As such, one skilled in the art will recognize that shunt plates can be added and/or substrate thicknesses can be increased to increase forces and use of a shunt plate(s) can allow thinner substrates to be used to achieve comparable force characteristics.

To create correlated magnetic structure prototypes, commercial off-the-shelf magnets were magnetically coded using a proprietary magnetizer that functions as a magnetic printer such as described in previously referenced U.S. Pat. No. 8,179,219, which magnetically prints pixel-like magnetic elements referred to as maxels into magnetizable material. Magnetic properties of the prototypes were characterized using test equipment for measuring magnetic fields and forces.

A simple and efficient method for creating the ring pattern is to begin with a conventional magnet with its original homogeneous magnetization, and then use the magnetic printer to write the opposite-polarity magnetization ring around its rim.

Depending on the print head used with the magnetic printer and the thickness of the substrate, it may be necessary to write complementary maxel patterns on the opposite face of the substrate so that magnetization reaches entirely through the substrate's thickness. Specifically, a North-polarity ring can be written on the rim of the South face of the conventional magnet, and a South-polarity ring can be written on the rim of its North face.

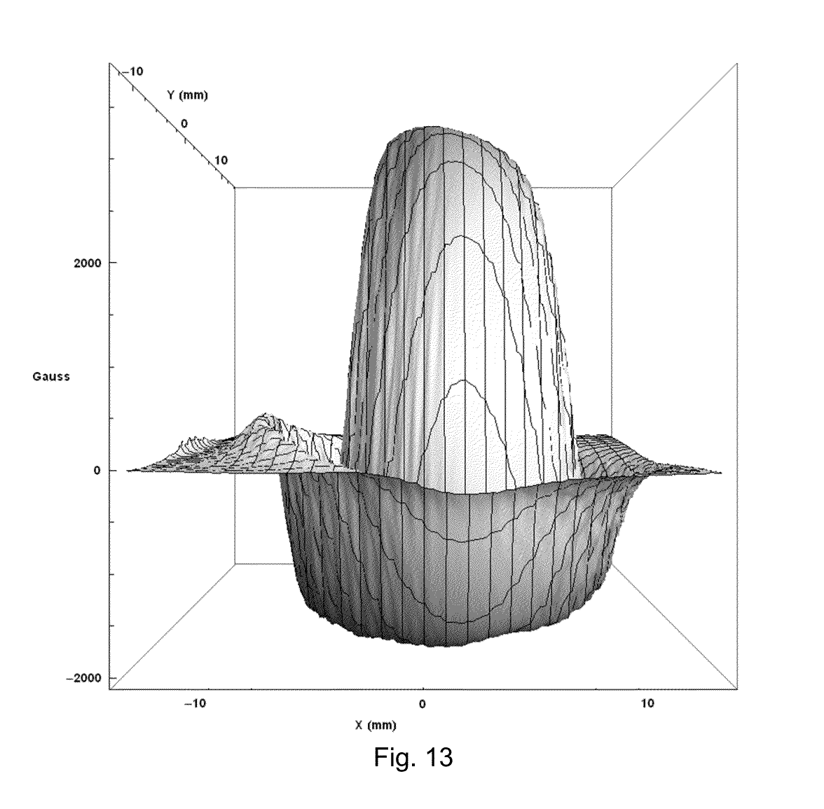

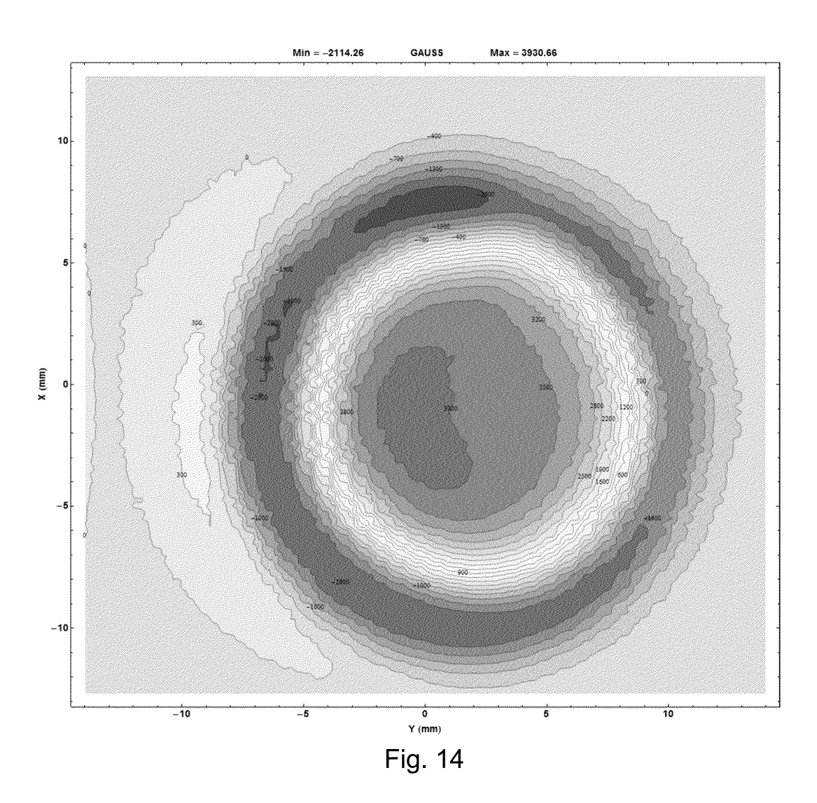

FIGS. 13 and 14 depict surface and contour plots of the vertical magnetic field component 0.5 mm above the surface of a prototype correlated magnetic structure, respectively.

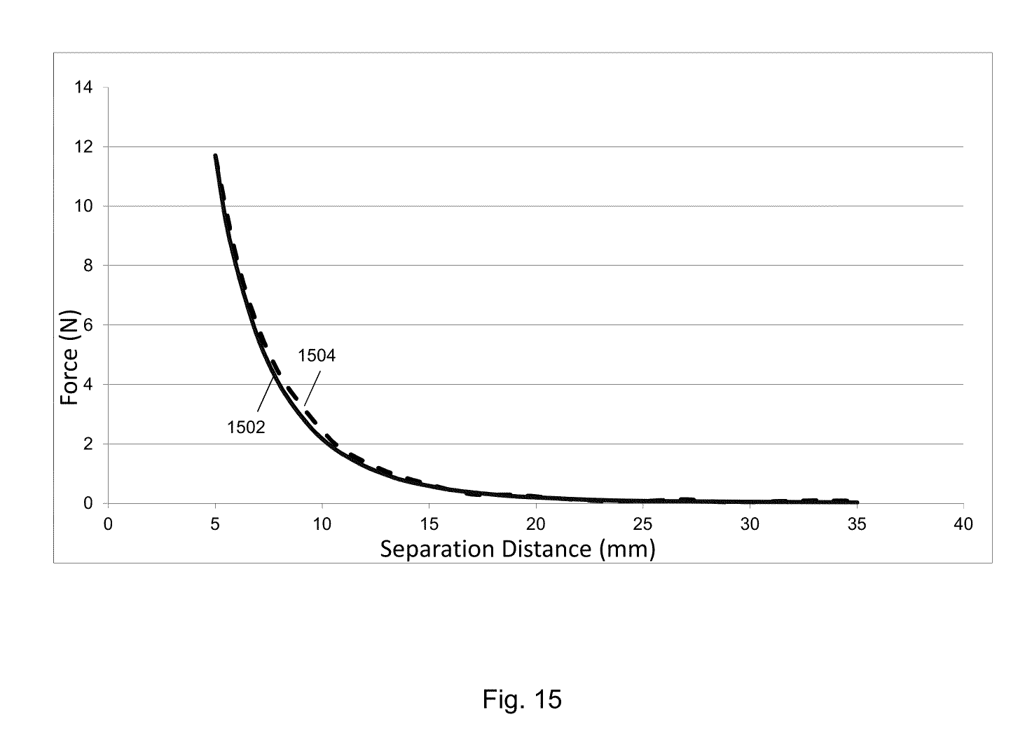

Table 2 lists the measured tensile force between the magnetic structures in a single correlated magnetic structure pair for each of several vertical separation distances. FIG. 15 shows the force curve of that data superimposed with the simulated-force data curve from FIG. 12, where the simulated data corresponds to the solid curve 1502 and the measured data corresponds to the dashed curve 1504.

TABLE 2
Measured tensile force between the magnetic
structures of a correlated magnetic structure pair

| Separation (mm) | Force (N) |
|---|---|
| 5 | 11.7 |
| 5.5 | 9.45 |
| 6 | 7.92 |
| 6.5 | 6.64 |
| 7 | 5.54 |
| 7.5 | 4.69 |
| 8 | 3.99 |
| 8.5 | 3.42 |
| 9 | 2.94 |
| 9.5 | 2.51 |
| 10 | 2.16 |
| 10.5 | 1.87 |
| 11 | 1.63 |
| 12 | 1.24 |
| 13 | 0.95 |
| 14 | 0.73 |
| 16 | 0.45 |
| 18 | 0.29 |
| 19 | 0.23 |
| 20 | 0.19 |
| 23 | 0.1 |
| 25 | 0.07 |
| 28 | 0.05 |
| 35 | 0.02 |

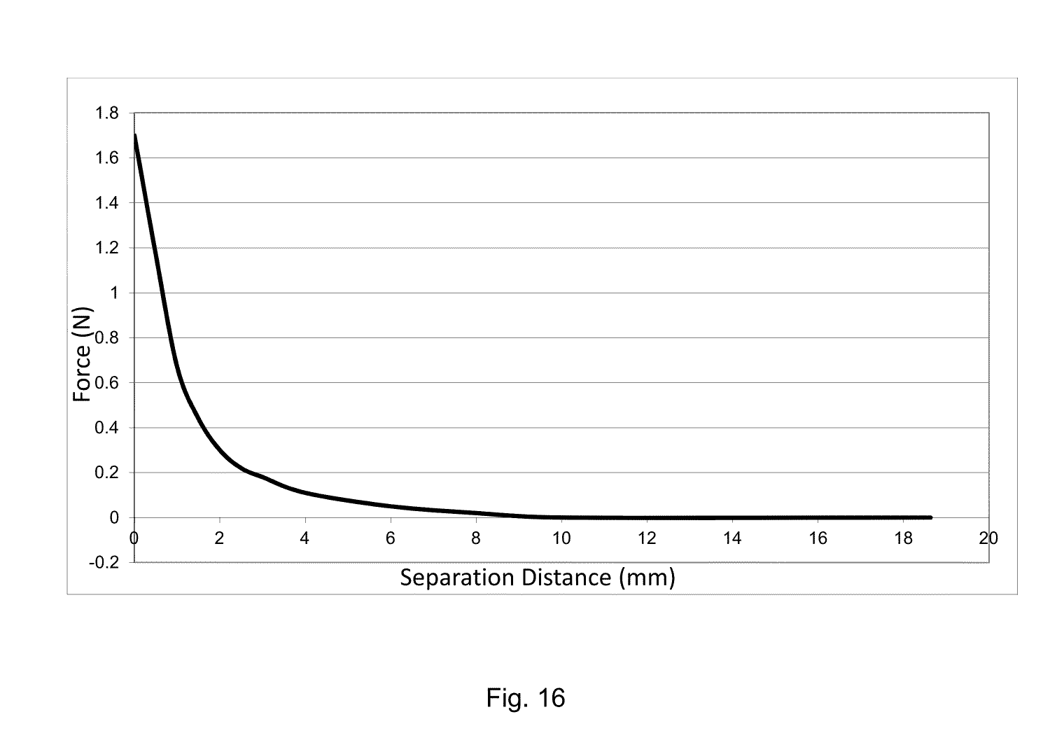

FIG. 16 shows the measured horizontal (i.e., undesirable) force between two top magnetic structures of two adjacent magnetic structure pairs for each of several horizontal separation distances. The right-most point in that curve represents the undesirable horizontal force between correlated magnetic structure centers with approximately 18.6 mm separation between correlated magnetic structures.

The focused field magnetic structure prototypes demonstrated that magnetic structures having inner and outer portions having an opposite polarity relationship can be smaller than the conventional magnets normally required to produce comparable tensile force yet have far less undesirable horizontal forces thereby allowing much denser placement of devices where magnetic interaction between devices is undesirable.

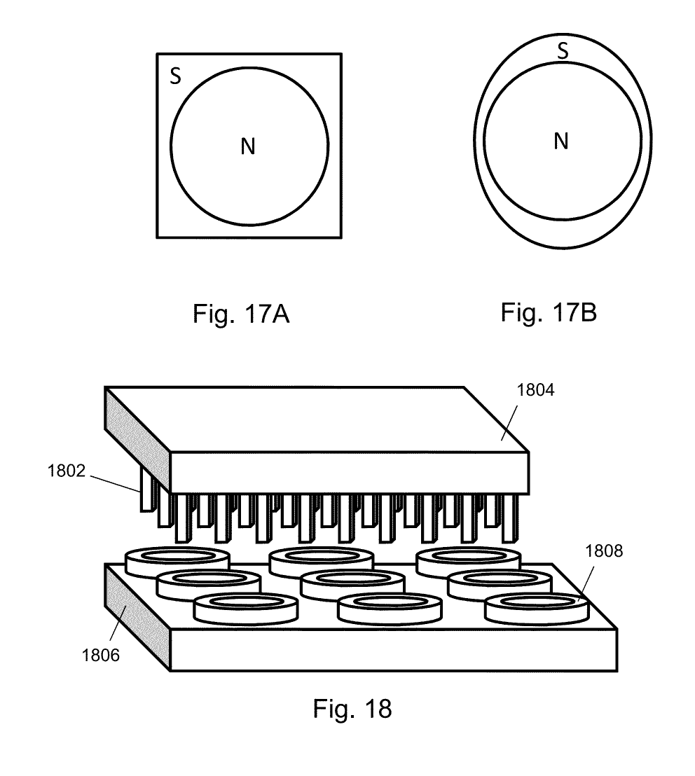

In accordance with another embodiment of the invention, the focused field magnetic structure design described above in relation to FIG. 9 can be produced using separate conventionally magnetized portions, where a perimeter ‘ring portion’ is magnetized with the opposite polarity of a ‘round portion’ located within the ring portion, where the thickness of that perimeter (i.e., ring portion) can be calibrated for minimum far field. Under one arrangement, a ring magnet is placed about a round (disc) magnet, where the ring magnet and disc magnet may fit together tightly or there could be a gap between them in which case a fixture would typically be employed to maintain symmetry. The ring and round portions of the combined magnetic structure can be of the same material (e.g., NIB or Alnico) and same grade or may be a combination of different materials or of different grades of the same material (N32 and N50). Moreover, the thickness of the ring and round portions can be the same or can be different. And, the width of the outer (ring) portion and the inner (round) portion can be non-uniform such that the outer portion isn't precisely a ring and the inner portion isn't precisely round. Generally, the two portions don't have to be the same shape depending on the type of side vs. surface field characteristics desired as depicted in FIGS. 17A and 17B.

A focusable correlated magnetic structure design can also be implemented by printing opposite polarity maxels onto a conventional axially magnetized magnet. Specifically, maxels can be printed on the ring portion and/or they can be printed on the round portion. Similarly, maxels can be printed on non-magnetized magnetizable material having domains oriented for axial printing. Similarly, maxels can be printed in the same direction as diametrically magnetized magnets were magnetized.

Printed maxels can have different field strengths so as to tailor field characteristics. They can overlap and can include maxels of the opposite polarity so as to increase shortest path effects. Printed maxels can also coded to have a preferred rotational and/or translational alignment, to have unique identities, and/or to have desirable correlation properties as has been described in US patents and pending non-provisional patent applications incorporated by reference above.

Although focusable correlated magnetic structures would typically have some degree of circular symmetry it isn't necessary that they have that much circular symmetry. They need not be round, but could instead be square-shaped, rectangular-shaped, or any other desired shape such as a polygon shape. They could also be comprised of concentric or stacked polygons or combinations of different closed geometric shapes.

Since a focusable correlated magnetic structure can be comprised of multiple simpler focusable correlated magnetic structures sharing the same axis or nearly the same axis, such an arrangement of focusable correlated magnetic structures can also be considered a focusable correlated magnetic structure or a focusable correlated magnetic structure array.

The advantage of these structures is that they can use concentric and stacked patterns of magnetic objects with different magnetization patterns and vectors and magnetic properties in order to produce a variety of circularly and pseudo-circularly symmetric magnetic fields and force behaviors.

And as always, the behavior can be statically or dynamically controlled by altering any combination of the magnetization pattern geometry, geometry and positions of the magnetic objects, magnetic material attributes, and the geometry and electrical signal in one or more electromagnets within the focusable correlated magnetic structures. Various types of movement constraining devices can be employed to maintain alignment of the magnetic structures by constraining rotational and/or translational movement. For example, the top and bottom magnetic structures may be constrained such that the top and bottom structures can rotate relative to each other and move up and down relative to each other but otherwise their alignment is maintained relative to an axis perpendicular to the two structures.

For circularly symmetric focusable correlated magnetic structures, the unique pattern appears in an imaginary radial slice. That pattern can be one or two dimensional, continuous or segmented.

For focusable correlated magnetic structures using a pattern of concentric rings, we can simplistically describe that pattern by describing the magnetization directions of each concentric ring from the innermost region outward, using cardinal directions. By convention, North will be up the axis of the focusable correlated magnetic structure, South will be down the axis, East will be outward from the center and West will be inward. For example a focusable correlated magnetic structure that is a disk with an inner magnetization pointing up its axis and an outer ring with a magnetization pointing outward from the center, has a “N, E” pattern. A focusable correlated magnetic structure with three concentric regions, where the inner region is magnetized downward, the next ring out is magnetized inward, and the outer ring is magnetized outward, would have a “S, W, E” pattern.

The above terminology can also be used to describe stacked patterns counting down the axis, as long that difference is made clear.

For zero side field strength, the total magnetization vector at the desired distance must simply be zero. So to make a zero side far-field with a “N, S” pattern, the volume of the outer ring should equal the volume of the inner ring, assuming they have the same coercivity.

A focusable correlated magnetic structure having a North ring portion and a South round portion aligned with a conventional magnet of the same diameter can have a multi-level magnetism behavior such as a contactless attachment behavior or a repel and snap behavior, depending on what faces of the structures are facing each other, which takes advantage of the high spatial frequency in the magnetic field on the edge of a conventional magnet.

A focusable correlated magnetic structure having a North ring portion and a South round portion aligned with a smaller conventional magnet (about the diameter of the correlated magnetic structure's inner region) will exhibit stronger repel or attraction than two conventional magnets of the same size as the correlated magnetic structure.

A focusable correlated magnetic structure having a North ring portion and a South round portion aligned with another focusable correlated magnetic structure having the same sized North ring portion and same sized South round portion will have strong near-field repel or attract.

Focusable correlated magnetic structures yield good performance on substrates not much bigger than the smallest maxel that the magnetic printer can create.

A multi-level magnetism version of a focusable correlated magnetic structure can be implemented with a reach comparable to the size of the substrate, where “reach” corresponds to the transition point in the composite force curve.

Sets of linear focusable correlated magnetic structures can be slid along their common axis to dynamically change their behavior.

Focusable correlated magnetic structures can be designed to produce a directive field, where the side field can have zero magnitude at a given distance.

A focusable correlated magnetic structure array can be used to support sensor applications such as guidance control systems whereby a focusable correlated magnetic structure array can be associated with a first object and one or more sensors (e.g., Hall effect sensors) can be associated with a second object to determine their relative position and/or to control movement of at least one of the objects relative to the other. An exemplary focusable correlated magnetic structure array and sensors are shown in FIG. 18. Referring to FIG. 18, a Hall Effect sensor array 1802 is associated with a first object 1804. The array 1802 determines the location of the first object 1804 relative to location of a second object 1806 by measuring the fields produced by a focusable correlated magnetic structure array 1808 associated with the second object 1806.

Similarly, a focusable correlated magnetic structure can be associated with a first object and one or more magnetically-sensitive materials (e.g., magnetic viewing film, YIG polarimetry film, or other magnetically reactive material) can be associated with a second object such that the focused magnetic field interacts with a portion of the magnetically-sensitive material and reacts less or does not react with an adjacent portion of the magnetically-sensitive material.

Similarly, a focusable correlated magnetic structure array can be associated with a first object and one or more ferromagnetic materials can be associated with a second object such that the focused magnetic field interacts with a one piece or portion of ferromagnetic material and reacts less or does not react with an adjacent piece or portion of the ferromagnetic material.

While particular embodiments of the invention have been described, it will be understood, however, that the invention is not limited thereto, since modifications may be made by those skilled in the art, particularly in light of the foregoing teachings.

1. A system for focusing magnetic fields, comprising:
a first focused field magnetic structure comprising a first inner portion and a first outer portion, said first inner portion being inside said first outer portion, said first inner portion and said first outer portion being magnetized to have an opposite polarity relationship; and
a second focused field magnetic structure comprising a second inner portion and a second outer portion, said second inner portion being inside said second outer portion, said second inner portion and said second outer portion being magnetized to have an opposite polarity relationship.

2. The system of claim 1, wherein said first focused field magnetic structure and said second focused field magnetic structure produce a composite magnetic field, wherein surface fields inside said first and second outer portions have substantially greater field strength than side fields outside said first and second outer portions.

3. The system of claim 1, wherein said first focused field magnetic structure comprises a monolithic substrate.

4. The system of claim 3, wherein said second focused field magnetic structure comprises a monolithic substrate.

5. The system of claim 1, wherein said first focused field magnetic structure comprises a first substrate having an axial magnetization profile and a second substrate having an axial magnetization profile.

6. The system of claim 5, wherein said second focused field magnetic structure comprises a third substrate having an axial magnetization profile and a fourth substrate having an axial magnetization profile.

7. The system of claim 1, further comprising a movement constraining device that constrains at least one of rotational movement or translational movement of at least one of said first focused field magnetic structure or said second focused field magnetic structure.

8. The system of claim 1, wherein magnetization of said first outer portion is symmetrical.

9. The system of claim 1, wherein magnetization of said second outer portion is symmetrical.

10. The system of claim 1, wherein said first inner portion is round and said first outer portion is a ring.

11. The system of claim 1, wherein said second inner portion is round and said second outer portion is a ring.

12. The system of claim 1, wherein at least one of said first focused field magnetic structure or said second focused field magnetic structure comprises a pattern of concentric rings.

13. A method for focusing magnetic fields, comprising the steps of:
providing a first focused field magnetic structure comprising a first inner portion and a first outer portion, said first inner portion being inside said first outer portion, said first inner portion and said first outer portion being magnetized to have an opposite polarity relationship; and
providing a second focused field magnetic structure comprising a second inner portion and a second outer portion, said second inner portion being inside said second outer portion, said second inner portion and said second outer portion being magnetized to have an opposite polarity relationship.

14. The method of claim 13, wherein said first focused field magnetic structure is a monolithic substrate having been axially magnetized prior to said first outer portion being magnetized to have said opposite polarity relationship.

15. The method of claim 14, wherein said second focused field magnetic structure is a monolithic substrate having been axially magnetized prior to said second outer portion being magnetized to have said opposite polarity relationship.

16. The method of claim 13, wherein said first focused field magnetic structure comprises a first substrate having an axial magnetization profile and a second substrate having an axial magnetization profile.

17. The method of claim 16, wherein said second focused field magnetic structure comprises a third substrate having an axial magnetization profile and a fourth substrate having an axial magnetization profile.

18. The method of claim 13, wherein said first focused field magnetic structure and said second focused field magnetic structure produce a composite magnetic field, wherein surface fields inside said first and second outer portions have substantially greater field strength than side fields outside said first and second outer portions.

19. The method of claim 13, further comprising the step of:
constraining at least one of rotational movement or translational movement of at least one of said first focused field magnetic structure or said second focused field magnetic structure.

20. The method of claim 1, wherein at least one of said first focused field magnetic structure or said second focused field magnetic structure comprises a pattern of concentric rings.
